(19) United States
(12) Patent Application Publication
(10) Pub. No.: US 2007/0221852 A1
(43) Pub. Date: Sep. 27, 2007

(54) Mobile SPECT retrofit for CT scanner

(76) Inventor: Markus Lusser, Cary, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/387,180

(22) Filed: Mar. 23, 2006

(51) Int. Cl. G01T 1/166

(52) U.S. Cl. 250/363.05

(57) ABSTRACT

A compact mobile SPECT imaging device generally includes a base assembly, a control tower assembly, a linkage assembly and a pair of detectors. The base assembly includes a plurality of wheels such that the base assembly can be removably positioned between a gantry of an existing CT imaging device and a subject table. Preferably, the detectors of the compact mobile SPECT imaging device are oriented with respect to one another at an angle of 90°. Preferably, the compact mobile SPECT imaging device includes at least one electrical input/output for electrically connecting a peripheral device, such as a computer that is also electrically connected to an existing CT imaging device.

### FIELD OF THE INVENTION

The instant invention relates generally to nuclear medical imaging devices, and more specifically, to a compact mobile SPECT nuclear imaging device that is used in conjunction with an existing CT nuclear imaging device such that both diagnostic modalities can be conducted in a single scanning session.

### BACKGROUND OF THE INVENTION

Nuclear medicine is a unique medical specialty wherein radiation is used to acquire images which show the function and anatomy of organs, bones or tissues of the body. Radiopharmaceuticals are introduced into the body, either by injection or ingestion, and are attracted to specific organs, bones or tissues of interest. Such radiopharmaceuticals produce gamma photon emissions which emanate from the body and are captured by a scintillation crystal, with which the photons interact to produce flashes of light or “events.” Events are detected by an array of photodetectors, such as photomultiplier tubes, and their spatial locations or positions are calculated and stored. In this way, an image of the organ or tissue under study is created from detection of the distribution of the radioisotopes in the body.

In nuclear imaging, a patient is injected with or swallows a radioactive isotope which has an affinity for a particular organ, structure or tissue of the body. Gamma rays are then emitted from the body part of interest, are collimated by a collimator so that only gamma photons traveling in a direction perpendicular to the surface of a detector head are allowed to impinge on the detector head, and are detected by a gamma camera apparatus including the detector head, which forms an image of the organ based on the detected concentration and distribution of the radioactive isotope within the body part of interest. Nuclear images may be obtained using Single Photon Emission Computed Tomography (SPECT). SPECT produces multiple image “slices,” each representing a different plane in a three-dimensional region, such that when the slices are considered collectively, a three-dimensional image of the region may be studied.

SPECT imaging is performed by using a gamma camera to acquire multiple images (also called projections) from multiple angles. A computer can then be used to apply a tomographic reconstruction algorithm to the multiple projections, yielding a 3D dataset.

To acquire SPECT images the gamma camera is rotated around the patient. Projections are acquired at defined points during the rotation, typically every 3-6 degrees. In most cases, a full 360 degree rotation is used to obtain an optimal reconstruction.

Multi-headed gamma cameras can provide accelerated acquisition. For example, a dual headed camera can be used with heads spaced 180 degrees apart, allowing 2 projections to be acquired simultaneously, with each head only requiring 180 degrees of rotation. Triple-head cameras with 120 degree spacing are also used.

Another known tomography system is computed axial tomography (CAT, or now also referred to as CT, XCT, or x-ray CT). In CT, an external x-ray source is caused to be passed around a patient. Detectors around the patient then respond to the x-ray transmission through the patient to produce an image of the area of study. Unlike SPECT, which is an emission tomography technique because it relies on detecting radiation emitted from inside the patient, CT is a transmission-tomography technique which utilizes a radiation source external to the patient. CT provides images of the internal structures of the body, such as the bones, whereas SPECT provides images of the functional aspects of the body, usually corresponding to an internal organ or tissue.

A CT scanner uses a similar mechanical setup as the SPECT scanner. However, unlike SPECT, a CT scanner requires detectors mounted opposite an x-ray source. In third-generation computed tomography systems, the CT detectors and x-ray source are mounted on diametrically opposite sides of a gantry which is rotated around the patient as the patient traverses the tunnel of the gantry.

The x-ray source of a CT imaging device typically emits a fan-shaped beam of x-rays which pass through the patient and are received by an array of detectors. As the x-rays pass through the patient, they are attenuated as a function of the densities of objects in their path. The output signal generated by each detector is representative of the electron densities of all objects between the x-ray source and the detector.

The CT detectors can utilize scintillator crystals which are sensitive to the energy level of the x-rays. Multiple light pulses produced by each scintillator crystal as it interacts with the x-rays are integrated to produce an output signal which is related to the number of the x-rays sensed by the scintillator crystal. The individual output signals are then collectively processed to generate a CT image. Other detectors can be used in CT tomographs. For example, a solid state silicon diode can be used to detect the low energy x-rays directly.

CT imaging is generally suited for providing anatomical and structural information, whereas SPECT is more adept for studying function and activity of tissue and organs. Consequently, it is particularly useful in certain studies such oncological and cardiology studies to use SPECT imaging for diagnostic purposes, and to align or register the nuclear image with a medical image from another modality such as CT, which offers better anatomical information. Such a fused image, for example, enables clinicians to determine the anatomical position of a lesion displayed by the nuclear image more accurately and the organs and structures that are affected can be ascertained with a higher degree of accuracy and confidence.

Hybrid imaging devices, which combine the functional sensitivity of SPECT with the anatomical detail of diagnostic multi-slice CT in a single, integral imaging device are known. However, such integrated devices are costly and impractical for diagnostic service providers that already possess stand alone-type CT imaging devices. Indeed, it may not be economically feasible for a diagnostic service provider to purchase a new, integrated hybrid device when such individual already possesses a stand alone-type CT imaging device. Additionally, in many instances, clinicians may have already constructed special buildings or rooms with which to house their existing stand alone-type CT imaging device such that the purchase of a new hybrid device may require the demolition and/or construction of a new building or room—which can be undesirable and/or cost prohibitive. Consequently, there is a need for a mobile compact SPECT imaging device that can be retrofitted with an existing stand alone-type CT imaging device to thereby form a hybrid device.

### SUMMARY OF THE INVENTION

A compact mobile SPECT imaging device according to the instant invention generally comprises a base assembly, a control tower assembly, a linkage assembly and at least one detector. The base assembly comprises a plurality of wheels and the compact mobile SPECT imaging device is removably positionable between a gantry of an existing stand alone-type CT imaging device and a subject table. In one embodiment, the compact mobile SPECT imaging device comprises a pair of detectors disposed with respect to one another at an angle of 90°. In another embodiment, the compact mobile SPECT imaging device further comprises at least one electrical input/output for electrically connecting a peripheral device. In still yet another embodiment, the peripheral device is a computer. In some embodiments, the computer is electrically connected to an existing CT imaging device. In one embodiment, the electrical input/output is a wireless connection.

In some embodiments of the invention, a compact mobile SPECT imaging device is associated with an existing stand alone-type CT imaging device comprising a gantry and a subject table and the compact mobile SPECT imaging device is removably positionable between the gantry and the subject table of the existing CT imaging device. In one embodiment, the compact mobile SPECT imaging device comprises a base assembly having a plurality of wheels, a control tower assembly, a linkage assembly, and preferably, a pair of detectors that are disposed with respect to one another at an angle of 90°. In another embodiment, the base assembly is positionable below the subject table. In some embodiments, the control tower comprises a motor that is mechanically connected to the linkage assembly and the linkage assembly is mechanically connected to the detectors such that the motors can rotate the detectors about an axis. In some embodiments, the compact mobile imaging device and/or the existing stand alone-type CT imaging device comprises an alignment assembly for properly positioning the compact mobile SPECT imaging device with respect to the existing CT imaging device and/or the table at a predetermined position. In some embodiments, the compact mobile SPECT imaging device and the CT imaging device are electrically connected to a common computer. In some embodiments, the compact mobile SPECT imaging device includes an onboard power source such as a rechargeable battery.

### BRIEF DESCRIPTION OF THE DRAWINGS

An exemplary embodiment of the instant invention will now be more fully described in the detailed description and accompanying figures that follow in which:

FIG. 1 is a perspective view of a known stand alone-type CT imaging device;

FIG. 2 is a perspective view of a known stand alone-type SPECT imaging device;

FIG. 3 is a perspective illustration of a known integral CT/SPECT imaging device;

FIG. 4 is a perspective view of an existing stand alone-type CT imaging device retrofitted with a compact mobile SPECT imaging device according to the instant invention;

FIG. 5 is a perspective view of a compact mobile SPECT imaging device according to the instant invention shown as being separated from an existing and alone-type CT imaging device; and,

FIG. 6 is a rear plan view of a compact mobile SPECT imaging device according to the present invention.

### DETAILED DESCRIPTION OF THE PREFERRED EMBODIMENTS

At the outset, it should be appreciated that the term/phrase “retrofit” and related terms/phrases is intended to refer to the fact that the present invention is configured to be combined, used in combination with, and/or mated with an existing stand alone-type CT imaging device. Additionally, the terms/phrases “open;” “open architecture” and related terms are intended to refer to generally non-annular imaging devices of the type that do not dispose a subject in and out of an orifice or tunnel and/or that do not wholly surround a subject.

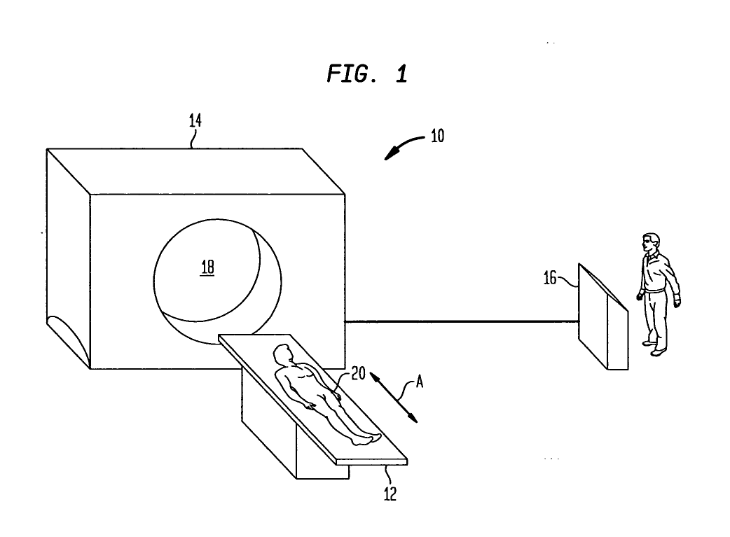

Referring now to the Figures, FIG. 1 illustrates an example of a known stand alone-type CT imaging device 10. Known stand alone-type CT imaging device 10 generally comprises table 12, gantry 14 and operator station 16. Table 12 is generally provided for supporting a subject to be examined thereon and can be inserted into and out of tunnel/orifice 18 of gantry 14 in the directions of arrow A. Gantry 14, which forms an annulus is provided for supporting and rotating one or more radiation sources and detectors (not shown) about a subject 20 to be examined such that image data regarding the subject can be collected. Operator station 16, which can include a computer, is provided for rendering diagnostic images using the collected image data. Operator station 16 can be located in a room separate from gantry 14. Such types of stand alone CT imaging devices are typically substantial in size and weight, have large footprints and are immobile. Often, rooms and/or buildings must be specifically constructed and/or designed in order to house such stand-alone CT imaging devices.

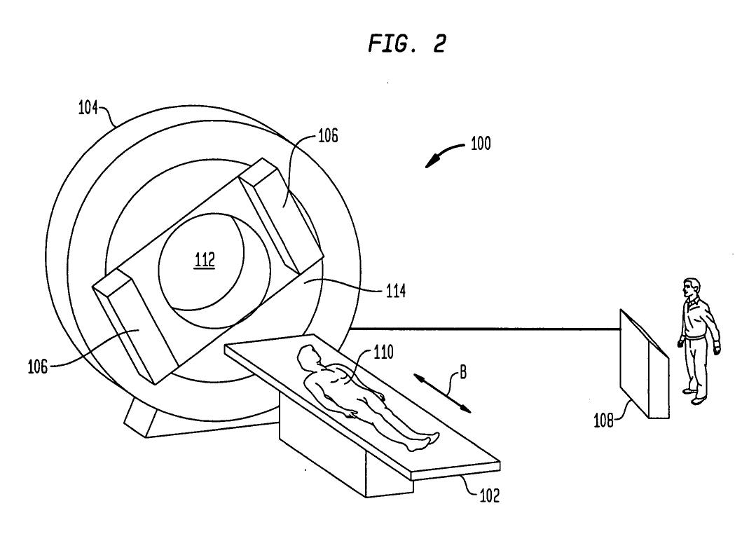

Referring now to FIG. 2, an example of a known stand alone-type SPECT imaging device 100 is seen as broadly comprising table 102, gantry 104, detectors 106 and operator station 108. Table 102 is generally provided for supporting a subject 110 thereon and is movable in and out of tunnel/orifice 112. Gantry 104 forms an annulus and is provided for supporting and rotating detectors 106 about subject 110. A rotational drive assembly including a rotating drum 114 and a drive motor and linkage assembly (not shown) is provided for rotating the drum and detectors about the subject. Generally, each of the detectors 106 comprises a scintillation crystal (not shown) that converts radiation that is received into flashes or scintillations of light, which are received by photomultiplier tubes (PMTs)(not shown) such that image data regarding the subject may be obtained. Operator station 108 can comprise a computer (not shown) that is used to prepare either two-dimensional (e.g., planar) images or three-dimensional (e.g., SPECT) images of the subject from the image data that is collected. Such types of stand alone-type SPECT imaging devices are typically substantial in size and weight, have large footprints and are immobile. Much like stand alone-type CT imaging devices, these devices also typically require that a special building or room be constructed to accommodate the device.

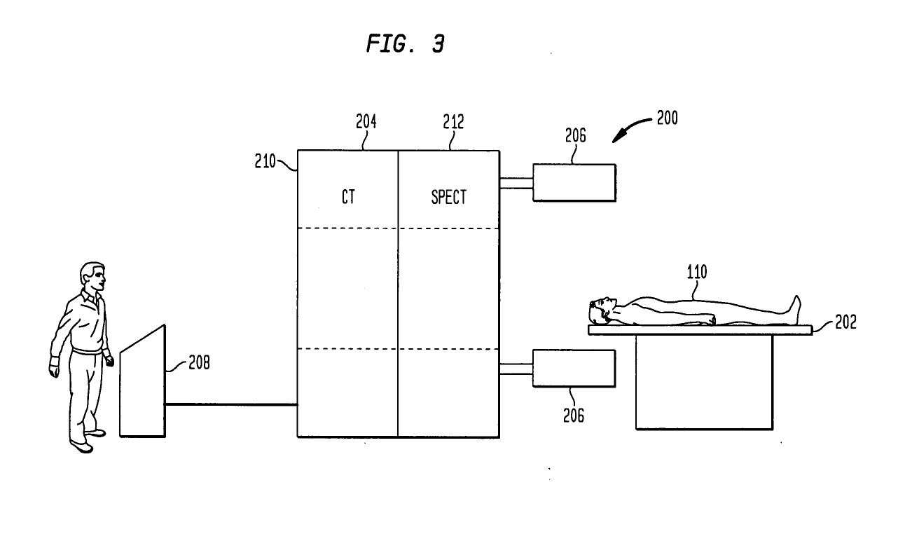

Referring now to FIG. 3, an example of a known integrated SPECT/CT imaging device 200 is illustrated as broadly comprising table 202, gantry housing 204, scintillating detectors 206 and operator station 208. Table 202 is generally provided for supporting a subject 110 thereon. Gantry housing 204 forms an annulus, which supports internal radiation source(s) and detector(s) therefor (not shown) for performing CT analyses on side 210 of housing 204 and supports a pair of external scintillating detectors 206 for performing SPECT analyses (which typically include collimators) on side 212 of housing 204. Operator station 208, which can comprise a computer, is provided for controlling the CT and/or SPECT analyses and also renders three dimensional images of a subject that is scanned. These devices are also typically substantial in size and weight, have large footprints and are generally immobile.

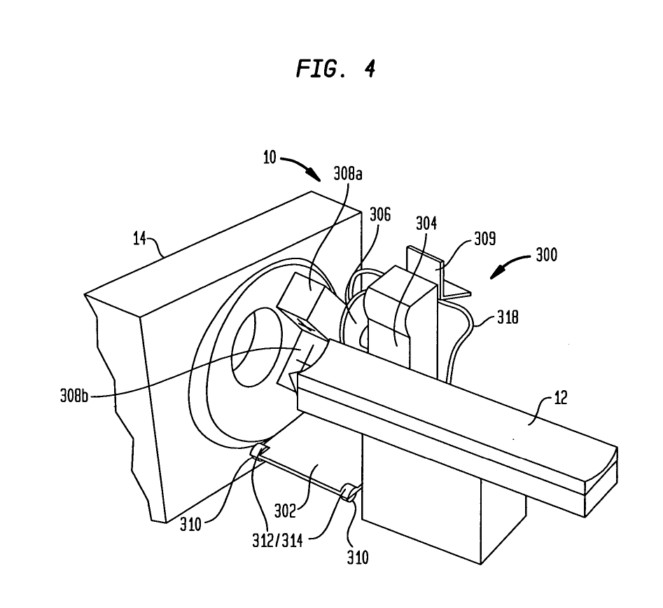

Referring now to FIG. 4, according to the instant invention, known stand-alone CT imaging device 10 is illustrated as being associated with a removably positionable compact mobile SPECT imaging device 300. More specifically, mobile compact SPECT imaging device 300 is illustrated as being positioned between subject table 12 and annular gantry 14 of stand alone-type CT imaging device 10. Compact mobile SPECT imaging device 300 generally comprises a base assembly 302, a control tower assembly 304, a linkage assembly 306, detectors 308a, 308b and an operator station 309, which alternatively, may be located in a separate room and in electronic communication with control tower assembly 304.

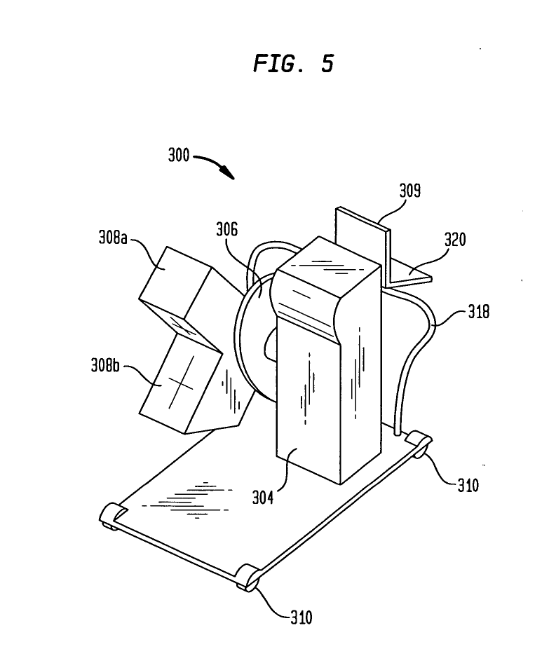

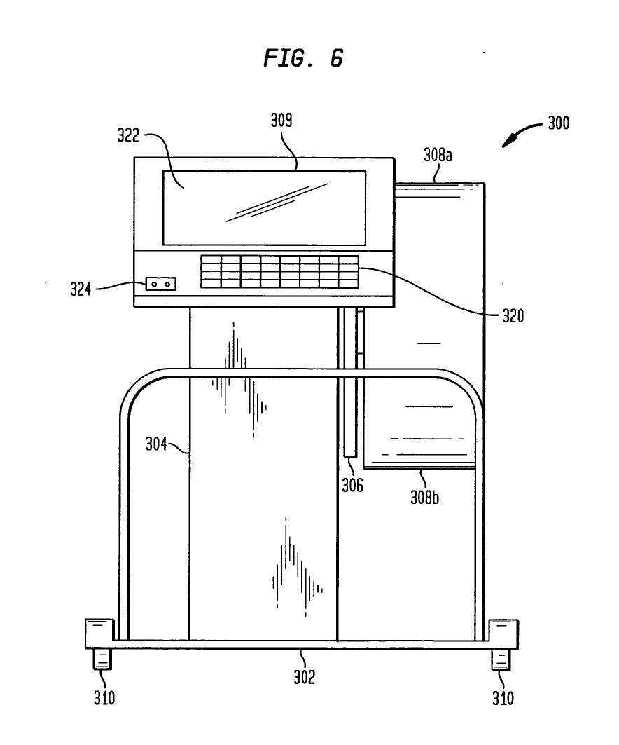

As illustrated more clearly in FIGS. 5 and 6, base assembly 302 is sized and shaped to be removably positioned between annular gantry 14 and subject table 12 and comprises a plurality of wheels 310 therefor. For purposes of providing stability to the compact mobile SPECT imaging device 300, wheels 310 are disposed at the corners of the base assembly, which is illustrated as being generally rectangular, planar and having a relatively low ground clearance. For purposes of easing movement, at least a pair of wheels 310 can be rotatable, for example, in the manner of casters, and/or can include wheel locks for preventing movement of the base assembly. Alternatively, base assembly 302 can be provided with footpads or shoes that can be extended so as to raise the wheels off of the floor to prevent movement of the SPECT imaging device 300. Base assembly 302, gantry 14 and/or subject table 12 can be configured to comprise alignment assemblies 312, 314 for properly disposing and/or locking the SPECT imaging device 300 at a predetermined position prior to performing a scanning procedure. Alignment assemblies 312, 314 can be fastened to one or more of the existing CT imaging device 10, subject table 12 and/or SPECT imaging device 300 to properly align such structures relative to one another. Base assembly 302 can also be configured to comprise a power cord that can be plugged into a central power source, such as a wall outlet. Such power cord may be retractable, if desired. In addition, or in the alternative, base assembly 302 can be configured comprise an onboard power source, such as a rechargeable battery. Such onboard power source can allow the compact mobile SPECT imaging device to be used without having to connect the device to a central power source. This is advantageous because existing CT imaging devices may not comprise auxiliary power outlets for receiving a power cord therein and/or it may not be desirable to extend a power cord across a room to a power outlet. In the embodiment illustrated, base assembly 302 also comprises handle assembly 318, for moving the device. Base assembly 302 is further provided for securing control tower assembly 304.

Control tower assembly 304 is generally provided for serving as a support for detectors 308a, 308b, which are connected thereto by linkage assembly 306. Control tower assembly 304 houses motion control devices (not shown), for example, motors, which work in conjunction with linkage assembly 306 to cause movement of the detectors. Detector movements can include, but are not limited to: up, down, left or right, inward and outward, and rotation about one or more axes. Control tower assembly 304 may also be configured to comprise a computer 320, which can be a laptop type computer, a display 322 and/or communications link 324 for connecting the mobile SPECT imaging device 300 with existing CT imaging device 10, for example, for sending/receiving commands from one device to the other, for displaying image information, or for registering SPECT image data with CT image data, etc. Communications link 324 can be a wired or wireless (e.g., RF, microwave, light, infrared, etc.) connection.

In the embodiment illustrated, detectors 308a, 308b are connected and disposed with respect to one another at an angle of approximately 90° to thereby provide an open-type architecture. Detectors 308a, 308b can be of a type generally known in the art and can comprise collimators and scintillating crystals, which are placed between the subject table and the gamma ray camera. In general, the collimators help to eliminate substantially all photons but those photons traveling in a desired direction and the scintillating crystals produce a flash, or light event, when a gamma photon collides therewith and is absorbed therein. Detectors 308a, 308b are generally configured for being rotated about a subject disposed on subject table 12 and receiving gamma photons that emanate from the subject. It should be appreciated by those having ordinary skill in the art that while the illustrated embodiment preferably discloses a pair of detectors 308a, 308b as being connected to one another and oriented with respect to one another at an angle of 90°, one or more detectors may be utilized and/or a number of detectors may be independently movable with respect to one another such that the angles of orientation therebetween may be modified.

Finally, as previously noted, computer 320 of the mobile SPECT imaging device can be utilized for outputting images data and registering SPECT image data with CT image data. Computer 320 generally comprises a central processing unit (CPU) in communication with the existing CT imaging device. Computer 320 can include various input/output (I/O) device(s) communicating over a bus, including, for example, a keyboard, a mouse, a video monitor, a printer, and/or other devices. In some embodiments, the CPU can communicate with a computer readable medium (e.g., conventional volatile or non-volatile data storage devices) (hereinafter “memory”) over the bus. The memory can include, e.g., data and software for performing a plurality of various imaging operations. Generally, the system geometries of the two devices are known; that is, the offset between the Field of View (FOV) of the compact mobile SPECT imaging device and that of the existing CT imaging device are known.

In a first method of registering images, the FOV of the SPECT system can be positioned using a Patient Positioning Monitor (PPM) in a known manner that is similar to that which is currently done using a stand-alone SPECT system. Then, the extent of the CT scan can be matched to cover the FOV of the SPECT scan. In a second method, the extent of the CT scan can be specified to be a sub-portion of that covered in the PPM. In various embodiments, any desired method of specifying can be employed, such as, by way of example, using marker lines on the PPM. In this manner, lines or the like can be used to specify a sub-portion of the PPM image in which to acquire CT image data. Among other things, this can help to limit the amount of x-ray dose delivered to the patient by limiting the extent of the scan (e.g., in the axial direction).

In some embodiments of the above two cases, the only positioning information provided by the existing CT imaging device is the use of laser markers or physical landmarks. In some examples, if this information is not sufficient, then the system can be configured to allow the operator to acquire a CT Tomogram to use in conjunction with the PPM information. In some embodiments, this can be performed routinely, or, alternatively, it can be included optionally, as needed. Accordingly, a third positioning method is contemplated as described below.

In the third method, the PPM can be used in conjunction with a Tomogram (e.g., a CT Tomogram) by displaying PPM information along with the Tomogram image. In some examples, a simplified method of doing this can be to display the extent of the PPM FOV as an annotation overlaid on the Tomogram image. For example, in some embodiments, the system can be configured to enable a user to simply draw a box (such as, e.g., using any computer software GUI methodologies similar to that of other software applications) on the Tomogram indicating the position of the SPECT FOV. In some more sophisticated methods, the PPM image is stored and that image is overlaid (e.g., using alpha blending or other techniques) with the Tomogram. In some embodiments, the user can then set the extent of the CT scan using the registered data from both modalities.

In some embodiments, the CT FOVs determined by the SPECT PPM images are treated as initial settings for the extent of the CT scan. In the preferred embodiments, however, the system is configured to allow the user to modify these extents to further refine the area to perform the CT scan. In these cases, it is useful to display the original PPM FOV even when the user has modified the scan extent (e.g., this can be helpful to enable the user to keep track and avoid losing this “landmark” information).

In some embodiments, the various methods described herein may be implemented via one or more computer program products for use with computer 320. This implementation may, for example, include a series of computer instructions fixed on a computer readable medium (e.g., a diskette, a CD-ROM, ROM or the like) or transmittable to a computer system via and interface device, such as a modem or the like. The medium may be substantially tangible (e.g., communication lines) and/or substantially intangible (e.g., wireless media using microwave, light, infrared, etc.). The computer instructions can be written in various programming languages and/or can be stored in memory device(s), such as semiconductor devices (e.g., chips or circuits), magnetic devices, optical devices and/or other memory devices. In the various embodiments, the transmission may use any appropriate communications technology.

While illustrative embodiments of the invention have been described herein, the present invention is not limited to the various preferred embodiments described herein, but includes any and all embodiments having equivalent elements, modifications, omissions, combinations (for example, various aspects in different embodiments can be combined together when appropriate in various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

What is claimed is:

1. In combination, a CT imaging device comprising a stationary gantry and a subject table, and a compact mobile SPECT imaging device retrofitted with said CT imaging device, said mobile SPECT imaging system being removably positionable between said gantry and said subject table.

2. The compact mobile SPECT imaging device of claim 1 comprising a base assembly, a control tower assembly, a linkage assembly and a pair of detectors disposed with respect to one another at an angle of 90°.

3. The compact mobile SPECT imaging device of claim 1 wherein said base assembly comprises a plurality of wheels.

4. The compact mobile SPECT imaging device of claim 1 wherein said base assembly is positionable below said subject table.

5. The compact mobile SPECT imaging device of claim 1 wherein said control tower comprises a motor, said motor mechanically connected to said linkage assembly, said linkage assembly mechanically connected to said detectors, said motor configured for rotating said detectors about an axis.

6. The compact mobile SPECT imaging device of claim 1 comprising an open configuration allowing positioning around said subject table.

7. The compact mobile SPECT imaging device of claim 1 comprising an alignment assembly, said alignment assembly positioning said compact mobile SPECT imaging device with respect to said existing CT imaging device and said table at a predetermined position.

8. The compact mobile SPECT imaging device of claim 1 comprising at least one input/output assembly, said input/output assembly connecting said compact mobile SPECT imaging device to a peripheral device.

9. The compact mobile SPECT imaging device of claim 8 wherein said connection is wired.

10. The compact mobile SPECT imaging device of claim 8 wherein said connection is wireless.

11. The compact mobile SPECT imaging device of claim 8 wherein said peripheral device is a computer.

12. The compact mobile SPECT imaging device of claim 11 wherein said compact SPECT imaging device and said existing CT device are electrically connected to said computer.

13. The compact mobile SPECT imaging device of claim 1 comprising an onboard power source.

14. The compact mobile SPECT imaging device of claim 13 wherein said power source is rechargeable.

15. A compact mobile SPECT imaging device comprising:
a base assembly, a control tower assembly, a linkage assembly and a pair of detectors disposed with respect to one another at an angle of 90°, said base assembly comprising a plurality of wheels, said base assembly removably positionable between a gantry of a stationary CT imaging device and a subject table, said compact mobile SPECT imaging device further comprising at least one electrical input/output for electrically connecting said SPECT imaging device to a peripheral device.

16. The compact mobile SPECT device of claim 15 wherein said peripheral device is a computer.

17. The compact mobile SPECT imaging device of claim 16 wherein said computer is electrically connected to said existing CT imaging device.

18. The compact mobile SPECT device of claim 15 wherein said electrical input/output is wireless.

19. A compact mobile SPECT imaging device comprising:
a base assembly, a control tower assembly, a linkage assembly and a pair of detectors, said base assembly comprising a plurality of wheels, said compact mobile SPECT imaging device removably positionable between a gantry of a stationary CT imaging device and a subject table.

20. The compact mobile SPECT imaging device of claim 19 wherein said detectors are disposed with respect to one another at an angle of 90°.
